(19) United States
(12) Patent Application Publication
(10) Pub. No.: US 2011/0122379 A1
(43) Pub. Date: May 26, 2011

(54) FILTER HOLDING APPARATUS, EXPOSURE APPARATUS, AND METHOD FOR PRODUCING DEVICE

(75) Inventors: Koichi KATSURA, Kumagaya-shi (JP); Tsukasa OGIWARA, Kumagaya-shi (JP); Keiji MATSUURA, Saitama-shi (JP); Yoshinari HORITA, Kounosu-shi (JP); Takashi MASUKAWA, Yokohama-shi (JP)

(73) Assignee: NIKON CORPORATION, Tokyo (JP)

(21) Appl. No.: 12/945,042

(22) Filed: Nov. 12, 2010

Related U.S. Application Data
(60) Provisional application No. 61/272,864, filed on Nov. 12, 2009.

(51) Int. Cl. G03B 27/52; B01D 46/12

(52) U.S. Cl. 355/30; 55/482; 355/77

(57) ABSTRACT

A filter holding apparatus holding a first chemical filter and a second chemical filter, includes a first frame which holds the first chemical filter and which has a first guide groove provided on a side surface of the first frame; a second frame which holds the second chemical filter and which has a second guide groove provided on a side surface of the second frame and which is arranged while being overlapped with the first frame; and each of the first and second guide grooves has a first groove which is communicated with a back surface of one of the first and second frames, and a second groove which is communicated with the first groove and which extends toward an upper end of one of the first and second frames; wherein a distance between the second groove and the back surface in the first frame is different from a distance between the second groove and the back surface in the second frame. A plurality of filters can be installed or exchanged efficiently and in such a manner that the filters are positioned easily.

### BACKGROUND OF THE INVENTION

1. Field of the Invention

The present invention relates, for example, to a filter holding apparatus which holds a plurality of filters for removing any impurity, etc. contained in a gas, an exposure apparatus provided with the filter holding apparatus, and a device producing method for producing, for example, a semiconductor element, a liquid crystal display element, or an image pickup element by using the exposure apparatus.

2. Description of the Related Art

In order to obtain a high exposure accuracy (resolution, positioning accuracy, etc.) in an exposure apparatus to be used in the lithography step of producing an electronic device (microdevice) including for example a semiconductor element, it is necessary that the illumination characteristic of an illumination optical system and the imaging characteristic of a projection optical system are maintained in predetermined states; and that the space, in which a reticle (or a photomask or the like), the projection optical system, and a wafer (or a glass plate or the like) are installed or placed, is maintained in a predetermined environment. For this purpose, the body section of the exposure apparatus (exposure apparatus-body section) including a part of the illumination optical system of the exposure apparatus, a reticle stage, the projection optical system, a wafer stage and the like has been hitherto installed in a box-shaped chamber. Further, an air-conditioning apparatus is provided, the air-conditioning apparatus supplying a clean gas (for example, air), which is controlled or regulated to have a predetermined temperature and which is allowed to pass through a dustproof filter or dust-preventive filter, into the chamber in accordance with the down flow system and the side flow system.

As for the exposure apparatus, in order to respond to the request for realizing an extremely fine circuit pattern in recent years, the wavelength of the exposure light (exposure light beam) is progressively shortened. Recently, the KrF excimer laser (wavelength: 248 nm) and the ArF excimer laser (wavelength: 193 nm) substantially in the vacuum ultraviolet region are used as the exposure light. In a case that the exposure light having such a short wavelength is used, if a minute amount of any gas of organic matter (organic gas) is present in a space (for example, the internal space in a barrel) through which the exposure light is allowed to pass, then the transmittance of the exposure light is lowered, and it is feared that any cloudiness substance may be produced on a surface of an optical element such as a lens element or the like on account of the reaction between the exposure light and the organic gas. Further, it is desirable that a gas of alkaline substance (alkaline gas) or the like, which reacts with the photoresist (photosensitive material) coated on the wafer, is also removed from the gas to be supplied into the chamber.

In view of the above, a plurality of chemical filters have been hitherto provided at a gas take-in portion of the air-conditioning apparatus of the exposure apparatus in order to remove, for example, the organic gas and/or the alkaline gas from the gas to be supplied into the chamber (see, for example, International Publication No. 2004/108252).

In a conventional exposure apparatus, a plurality of chemical filters have been stacked while being positioned in a casing. Therefore, when the chemical filters are exchanged, it is necessary that used chemical filters are successively unloaded, and then unused chemical filters are stacked and installed while being mutually positioned. Therefore, the time, which is required to exchange the chemical filters, is prolonged and/or it is feared that positional deviation or shift may be caused between the plurality of chemical filters, and the gas-tightness may be lowered between the chemical filters.

Further, in the exposure apparatus, the number of stages of the installed chemical filters is increased corresponding to the further improvement in the required exposure accuracy. Therefore, it is necessary that the chemical filters should be exchanged efficiently.

### SUMMARY OF THE INVENTION

Taking the foregoing circumstances into consideration, an object of the present invention is that a plurality of filters can be installed or exchanged efficiently or the filters can be positioned with ease.

According to a first aspect, there is provided a filter holding apparatus which holds a plurality of filters, the filter holding apparatus comprising: a first filter and a second filter; a box-shaped first frame which holds the first filter and which has a first protrusion/recess-formed portion provided on at least one side surface of the first frame; and a box-shaped second frame which holds the second filter, which has a second protrusion/recess-formed portion provided on at least one side surface of the second frame, and which is arranged while being overlapped with the first frame;

wherein the first protrusion/recess-formed portion has a first recess which is arranged between an upper end and a lower end of the at least one side surface of the first frame and which is communicated with a side end of the at least one side surface of the first frame, and a second recess which is communicated with the first recess and which extends toward the upper end of the at least one side surface of the first frame;

the second protrusion/recess-formed portion has a third recess which is arranged between an upper end and a lower end of the at least one side surface of the second frame and which is communicated with a side end of the at least one side surface of the second frame, and a fourth recess which is communicated with the third recess and which extends toward the upper end of the at least one side surface of the second frame; and

a positional relationship of the second recess with respect to the first recess and a positional relationship of the fourth recess with respect to the third recess are different from each other.

According to a second aspect, there is provided a filter holding apparatus comprising: a first filter and a second filter each of which removes a predetermined component contained in a gas; and a first frame which has a first surface, a second surface facing the first surface, a third surface intersecting the first surface, and a fourth surface facing the third surface, which surrounds the first filter with the first surface, the second surface, the third surface and the fourth surface, and in which a first recess and a second recess are formed in each of the third and fourth surfaces, the first recess having an end arriving at the second surface, and the second recess connecting to the first recess and extending at least in an upward direction; a second frame which has a first surface, a second surface facing the first surface, a third surface intersecting the first surface, and a fourth surface facing the third surface, which surrounds the second filter with the first surface, the second surface, the third surface and the fourth surface, and in which a third recess and a fourth recess are formed in each of the third and fourth surfaces, the third recess having an end arriving at the second surface, and the fourth recess connecting to the third recess and extending at least in the upward direction;

wherein a distance between the second recess and the second surface in the first frame is different from a distance between the fourth recess and the second surface in the second frame.

According to a third aspect, there is provided an exposure apparatus which exposes a substrate with an exposure light via a pattern, the exposure apparatus comprising: an exposure apparatus-body section which exposes the substrate; a chamber which accommodates the exposure apparatus-body section; the filter holding apparatus of the above-described aspect; and an air-conditioning apparatus which feeds a gas taken in from outside of the chamber into the chamber via the filter holding apparatus.

According to a fourth aspect, there is provided a method for producing a device, comprising exposing a photosensitive substrate by using the exposure apparatus; and processing the exposed photosensitive substrate.

According to the aspect, for example, by providing a first protrusion portion and a second protrusion portion on a side of a container which accommodates the first and second frames, and by moving the first and second frames so that the first and second protrusion portions are moved relative to (relatively moved with respect to) the first and second frames along the first protrusion/recess-formed portion of the first frame and the second protrusion/recess/formed portion of the second frame, the first and second frames can be efficiently installed and easily positioned with respect to the container and the first and second frames can be unloaded or transported out from the container efficiently. Thus, the first and second filters held by the first and second frames respectively can be installed efficiently or can be exchanged easily.

Further, since the positional relationship of the second recess with respect to the first recess of the first frame and the positional relationship of the fourth recess with respect to the third recess of the second frame are different from each other, it is possible, for example, when the kinds of the first and second filters are different, to avoid mistaken or incorrect install or placing positions for the first and second filters (frames) of which kinds are different from each other.

### BRIEF DESCRIPTION OF THE DRAWINGS

FIG. 1 shows, with partial cutaway, a construction of an exposure apparatus of a first embodiment.

FIG. 2 shows a perspective view illustrating a filter apparatus 26 shown in FIG. 1.

FIG. 3 shows, with partial cutaway, a front view illustrating the filter apparatus 26 shown in FIG. 2.

FIG. 4A shows a perspective view illustrating a filter box 38 shown in FIG. 3, FIG. 4B shows a side view illustrating the filter box 38, FIG. 4C shows a perspective view illustrating a filter box 40 shown in FIG. 3, and FIG. 4D shows a side view illustrating the filter box 40.

FIGS. 5A, 5B, 5C, and 5D show perspective views illustrating change of the relative position between the filter box 38 and a casing 28 respectively.

FIGS. 6A, 6B, 6C, and 6D show perspective views illustrating change of the relative position between the filter box 40 and the casing 28 respectively.

FIG. 7 shows a perspective view illustrating main components or parts of the casing 28.

FIG. 8A shows a perspective view illustrating a filter box 38A of a second embodiment, FIG. 8B shows a side view illustrating the filter box 38A, FIG. 8C shows a perspective view illustrating a filter box 40A of the second embodiment, and FIG. 9D shows a side view illustrating the filter box 40A.

FIGS. 9A, 9B, 9C, and 9D show perspective views illustrating change of the relative position between the filter box 38A and the casing 28 respectively.

FIGS. 10A, 10B, 10C, and 10D show perspective views illustrating change of the relative position between the filter box 40A and the casing 28 respectively.

FIG. 11 shows a flow chart illustrating exemplary steps of producing an electronic device.

### DESCRIPTION OF THE PREFERRED EMBODIMENTS

### First Embodiment

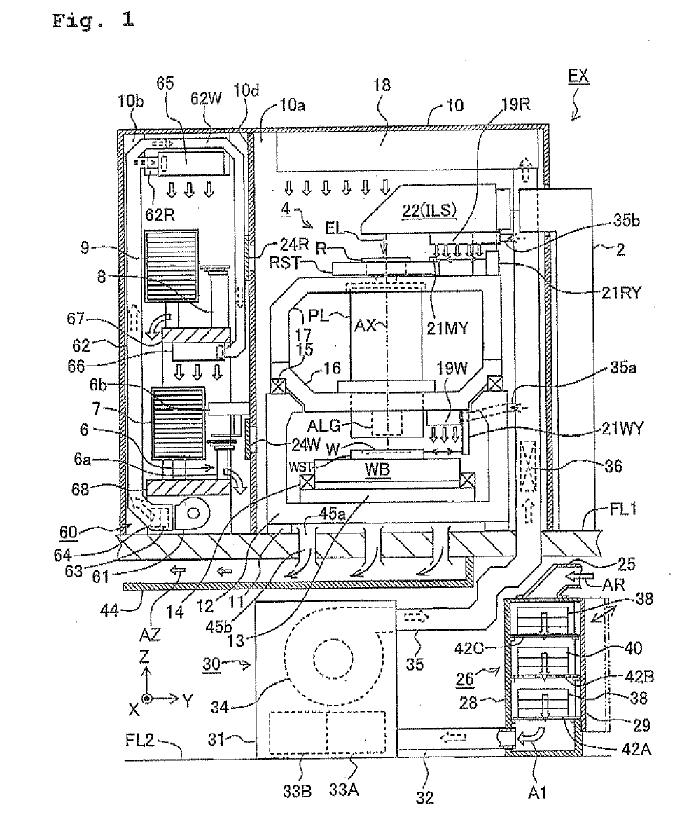

A first embodiment of the present invention will be explained below with reference to FIGS. 1 to 7.

FIG. 1 shows, with partial cutaway, an exposure apparatus EX according to this embodiment which is of the scanning exposure type and is constructed of a scanning stepper. With reference to FIG. 1, the exposure apparatus EX includes a light source section 2 which generates an exposure light (illumination light or illumination light beam for the exposure) EL, an illumination optical system ILS which illuminates a reticle R (mask) with the exposure light EL, a reticle stage RST which is movable while holding the reticle R, and a projection optical system PL which projects an image of a pattern of the reticle R onto a surface of a wafer W (substrate) coated with a photoresist (photosensitive material). The exposure apparatus EX further includes a wafer stage WST which is movable while holding the wafer W, other driving mechanisms, sensors, etc., a reticle library 9 which stores a plurality of reticles, a wafer cassette 7 which stores a plurality of unexposed wafers and/or a plurality of exposed wafers, and a main controller (not shown) which integrally controls the operation of the exposure apparatus EX. The members, which include those ranging from the light source section 2 to the main controller (not shown), are installed or placed, for example, on an upper surface of a first floor FL1 in a clean room of a semiconductor device production factory.

The exposure apparatus EX is provided with a box-shaped chamber 10 having a high gas-tightness and installed on the floor FL1. The interior of the chamber 10 is comparted or partitioned into an exposure chamber 10a and a loader chamber 10b, for example, by a partition member 10d which has two openings that are opened/closed by shutters 24R, 24W. An exposure apparatus-body section 4, which includes the illumination optical system US, the reticle stage RST, the projection optical system PL, and the wafer stage WST, is installed in the exposure chamber 10a. A reticle loader system and a wafer loader system, which include the reticle library 9 and the wafer cassette 7 respectively, are installed in the loader chamber 10b.

The exposure apparatus EX is provided with an overall air-conditioning system for performing the air-conditioning for the whole interior of the chamber 10. The overall air-conditioning system includes a filter apparatus 26 which is installed on an upper surface of a second floor FL2 of a machine room as the lower floor of the first floor FL1 and which has a plurality of stacked chemical filters, an air-conditioning apparatus 30 which has an air-conditioning apparatus-body section 31 installed on the upper surface of the floor FL2, a large-sized blow port 18 which is installed at an upper portion of the exposure chamber 10a, a small-sized blow port 19R which is arranged on a bottom surface of a subchamber 22 accommodating the illumination optical system ILS, and a small-sized blow port 19W which is arranged in the vicinity of the projection optical system PL. The filter apparatus 26 removes predetermined impurities from the air AR as the air-conditioning gas supplied via a piping 25 so that the air, from which the impurities have been removed, is supplied to the air-conditioning apparatus-body section 31 via a first duct 32 as indicated by an arrow A1 (details will be described later on).

The air-conditioning apparatus 30 includes the first duct 32, the air-conditioning apparatus-body section 31, a second duct 35 which connects the air-conditioning apparatus-body section 31 and the interior of the chamber 10 via an opening provided on the floor FL1, and a dustproof filter or dust-preventive filter 36 such as ULPA filter (Ultra Low Penetration Air-filter) or the like which is arranged, for example, at an intermediate position of the second duct 35 and which removes minute particles (fine particles) from the air flowing the inside of the second duct 35. Each of the ducts 32, 35 and the piping 25 is formed by using a material with which the amount of production of the contaminant or pollutant is small, including, for example, stainless steel and fluororesin.

The air-conditioning apparatus-body section 31 is provided with a temperature control section 33A which controls the temperature of the air supplied via the first duct 32, a humidity control section 33B which controls the humidity of the air, and a fan motor 34 which feeds the air toward the second duct 35. The air is controlled to have a temperature of, for example, 23° C. within a range of 20° C. to 30° C., and the air is supplied in accordance with the down flow manner or system into the exposure chamber 10a via the second duct 35 and the blow port 18. The interior of the chamber 10 is set to be in a state of positive pressure in accordance with the supply of the air. The air in the second duct 35 is supplied into the exposure chamber 10a via branched tubes 35a, 35b and the blow port 19W and the blow port 19R corresponding thereto. Apart of the air in the exposure chamber 10a is also allowed to flow into the loader chamber 10b.

As an example, the air, flowing through the interior of the chamber 10 (exposure chamber 10a), flows into an underfloor discharge duct 44 via a number of openings 45a provided on the bottom surface of the chamber 10 and a number of openings 45b provided on the floor FL1. The air in the discharge duct 44 is discharged after being cleaned via an unillustrated filter. All or a part of the air flowing to the discharge duct 44 can be also reused by returning all or the part of the air toward the piping 25.

With reference to FIG. 1, the following description will be made assuming that Z axis extends in parallel to an optical axis AX of the projection optical system PL, X axis extends perpendicularly to the sheet surface of FIG. 1 in a plane perpendicular to the Z axis (substantially parallel to a horizontal plane in this embodiment), and Y axis extends in parallel to the sheet surface of FIG. 1. In this embodiment, the scanning direction for the reticle R and the wafer W during the scanning exposure is the Y direction. The directions of rotation about the X axis, the Y axis, and the Z axis are also referred to as θx, θy, and θz directions.

At first, the light source section 2, which is installed on the floor FL1 and disposed outside the chamber 10, includes an exposure light source which generates or emits the ArF excimer laser beam (wavelength: 193 nm) as the exposure light (exposure light beam) EL, and a beam-feeding optical system which guides the exposure light EL to the illumination optical system ILS. The light-exit end of the exposure light EL of the light source section 2 is arranged in the exposure chamber 10a via an opening disposed at en upper portion of the side surface in the +Y direction of the chamber 10. Those usable as the exposure light source also include an ultraviolet pulsed laser light source such as a KrF excimer laser light source (wavelength: 248 nm) or the like, a high harmonic wave generating light source of YAG laser, a high harmonic wave generator of solid-state laser (semiconductor laser or the like), a mercury lamp (for example, i-ray), etc.

The illumination optical system ILS, which is arranged at the upper portion in the chamber 10, includes, for example, an illuminance-uniformalizing optical system including an optical integrator, a reticle blind, a condenser optical system, etc. as disclosed, for example, in United States Patent Application Publication No. 2003/0025890. A slit-shaped illumination area of a pattern surface of the reticle R, which is elongated or slender in the X direction and which is defined by the reticle blind, is illuminated with the exposure light EL at a substantially uniform illuminance by the illumination optical system ILS.

The image of the pattern in the illumination area, which is included in a pattern area formed on the reticle R, is projected and imaged on a surface of the wafer W via the projection optical system EL which is telecentric on the both sides and which has a projection magnification β of reduction magnification (for example, ¼).

A lower frame 12 is installed on the floor FL1 in the exposure chamber 10a of the chamber 10 via a plurality of bases 11. A flat plate-shaped base member 13 is fixed to a central portion of the lower frame 12. A flat plate-shaped wafer base WB is supported on the base member 13 via anti-vibration bases 14 which are disposed, for example, at three positions. The wafer stage WST is placed on the upper surface of the wafer base WB parallel to the XY plane via an air bearing so that the wafer stage WST is movable in the X direction and the Y direction and rotatable in the θz direction. An optical system frame 16 is supported at the upper end of the lower frame 12 via anti-vibration bases 15 which are disposed, for example, at three positions and which are arranged to surround the wafer base B. The projection optical system PL is arranged in an opening disposed at a central portion of the optical system frame 16. An upper frame 17 is fixed on the optical system frame 16 so that the projection optical system PL is surrounded thereby.

A Y axis laser interferometer 21WY is fixed at the end portion in the direction of the bottom surface of the optical system frame 16. An X axis laser interferometer (not shown) is fixed at the end portion in the +X direction of the bottom surface. A wafer interferometer, which is constructed of these interferometers, radiates a plurality of axes of measuring beams onto reflecting surfaces (or movement mirrors) disposed on side surfaces of the wafer stage WST respectively to measure the positions of the wafer stage WST in the X direction and the Y direction and the angles of rotation in the θx, θy, and θz directions, for example, with the references of reference mirrors (not shown) disposed on side surfaces of the projection optical system PL; and the wafer interferometer supplies measured values to the main controller (not shown).

A stage control system in the main controller (not shown) controls the positions and the velocities in the X direction and the Y direction and the angle of rotation in the θz direction of the wafer stage WST via a driving mechanism (not shown) including a linear motor or the like based on the measured value obtained by the wafer interferometer, a measured value obtained by en autofocus sensor (not shown), and/or the like. Further, the stage control system controls a Z stage (not shown) in the wafer stage WST so that the surface of the wafer W is focused on the image plane of the projection optical system PL. Further, an alignment system ALG, etc. is also provided in order to perform the alignment for the reticle R and the wafer W.

On the other hand, the subchamber 22, which accommodates the illumination optical system ILS, is fixed to the upper portion in the +Y direction of the upper frame 17. Further, the reticle stage RST is placed on the upper surface, of the upper frame 17, parallel to the XY plane via an air bearing so that the reticle stage RST is movable at a constant velocity in the Y direction, movable in the X direction, and rotatable in the θz direction.

A Y axis laser interferometer 21RY is fixed to the end portion in the direction of the upper surface of the upper frame 17. An X axis laser interferometer (not shown) is fixed to the end portion in the +X direction of the upper surface. A reticle interferometer, which is constructed of these interferometers, radiates a plurality of axes of measuring beams, for example, onto a movement mirror 21MY provided on the reticle stage RST respectively to measure the positions of the reticle stage RST in the X direction and the Y direction and the angles of rotation in the θz, θx, and θy directions, for example, with the references of reference mirrors (not shown) disposed on side surfaces of the projection optical system PL; and the reticle interferometer supplies measured values to the main controller (not shown).

The stage control system contained in the main controller (not shown) controls the position and the velocity in the Y direction, the position in the X direction, the angle of rotation in the θz direction, etc. of the reticle stage RST, via a driving mechanism (not shown) including a linear motor or the like based on, for example, the measured value obtained by the reticle interferometer.

In a case that the exposure apparatus EX of this embodiment is of the liquid immersion type, a predetermined liquid (pure or purified water, etc.) is supplied to a local liquid immersion area, disposed between the wafer W and an optical member arranged at the forward end of the projection optical system PL, from a local liquid immersion mechanism (not shown) including, for example, a ring-shaped nozzle head arranged at the lower surface of the optical member disposed at the lower end of the projection optical system PL. A liquid immersion mechanism, which is disclosed, for example, in United States Patent Application Publication No. 2007/242247, can be used as the local liquid immersion mechanism. In a case that the exposure apparatus EX is of the dry type, it is unnecessary to provide the liquid immersion mechanism.

The reticle library 9 and a reticle loader 8 as a horizontal articulated robot are installed on an upper surface of an upper support stand 67 in the loader chamber 10b. The reticle loader 8 exchanges the reticle R between the reticle library 9 and the reticle stage RST via the opening which is opened/closed by the shutter 24R of the partition member 10d.

A wafer cassette 7 and a horizontal articulated robot 6a for taking in and taking out the wafer with respect to the wafer cassette 7 are installed on an upper surface of a lower support stand 68 in the loader chamber 10b. A wafer transport apparatus 6b, which constructs the wafer loader 6 together with the horizontal articulated robot 6a, is installed over or above the horizontal articulated robot 6a. The wafer transport apparatus 6b transports the wafer W between the horizontal articulated robot 6a and the wafer stage WST via the opening which is opened/closed by the shutter 24W of the partition member 10d.

When the exposure apparatus EX performs the exposure, the alignment is firstly performed for the reticle R and the wafer W. After that, the radiation or irradiation of the exposure light EL onto the reticle R is started. An image of the pattern (pattern image) of the reticle R is transferred to one shot area on the surface of the wafer W in accordance with a scanning exposure operation in which the reticle stage RST and the wafer stage WST are synchronously moved (subjected to the synchronous scanning) in the Y direction at a velocity ratio of the projection magnification β of the projection optical system PL, while projecting an image of a part of the pattern of the reticle R onto the shot area on the surface of the wafer W via the projection optical system PL. After that, the pattern image of the reticle R is transferred to all shot areas of the wafer W in the step-and-scan manner by repeating an operation in which the wafer W is step-moved in the X direction and the Y direction via the wafer stage WST and the scanning exposure operation described above.

In the next viewpoint, the exposure apparatus EX of this embodiment is provided with the overall air-conditioning system including the air-conditioning apparatus 30 which supplies the temperature-regulated clean air into the chamber 10 in accordance with the down flow system as described above in order to perform the exposure at a high exposure accuracy (resolution, positioning accuracy, etc.) while maintaining the illumination characteristic (the illuminance uniformity, etc.) of the illumination optical system ILS and the imaging characteristic (resolution, etc.) of the projection optical system to be in predetermined states and maintaining the atmosphere (space) for placing or installing the reticle R, the projection optical system PL, and the wafer W therein to be in a predetermined environment.

The overall air-conditioning system is provided with a local air-conditioning section. That is, the temperature-regulated clean air is supplied from the branched tubes 35b, 35a of the second duct 35 to the blowing portion 19R disposed on the bottom surface of the subchamber 22 and the blowing portion 19W disposed on the bottom surface of the optical system frame 16 respectively. In this case, the blowing portions 19R, 19W are arranged on the optical paths of the measuring beams of the Y axis laser interferometer 21RY for the reticle stage RST and the Y axis laser interferometer 21WY for the wafer stage WST respectively. The blowing portions 19R, 19W respectively cause the temperature-regulated air to be blown onto the optical paths of the measuring beams at an approximately uniform air velocity distribution in accordance with the down flow system (or the side flow system as well). Similarly, the temperature-regulated air is also locally supplied to the optical paths of the measuring beams of the X axis laser interferometers. Accordingly, the positions of the reticle stage RST and the wafer stage WST can be measured highly accurately by the reticle interferometer 21R and the wafer interferometer 21W, etc.

A local air-conditioning apparatus 60 is installed in the loader chamber 10b. The local air-conditioning apparatus 60 is provided with a small-sized fan motor 61 which is arranged on the bottom surface of the support stand 68, a duct 62 which supplies the air fed by the fan motor 61 to the upper portion, and blow ports 65, 66 which are arranged over or above the reticle library 9 and the wafer cassette 7. The forward end portion of the duct 62 is divided into branched tubes 62R, 62W which supply the air to the blow ports 65, 66 respectively. Dustproof filters such as ULPA filters or the like are installed in the vicinity of air inflow ports of the blow ports 65, 66 respectively. Filter boxes 63, 64, which accommodate chemical filters for removing predetermined impurities, are installed in the duct 62 in the vicinity of the fan motor 61. As an example, the chemical filter of the filter box 63 removes the organic gas (gas of organic matter), and the chemical filter of the filter box 64 removes the alkaline gas (gas of alkaline substance) and the acid gas (gas of acid substance).

When the local air-conditioning apparatus 60 is operated in the loader chamber 10b, the air, which is fed from the fan motor 61, is supplied to the space in which the reticle library 9 and the wafer cassette 7 are arranged respectively in accordance with the down flow system from the blow ports 65, 66 via the filter boxes 63, 64 and the duct 62. The air flowing around the reticle library 9 is returned to the fan motor 61 via the surroundings of the support stand 67, the surroundings of the wafer cassette 7 disposed under or below the support stand 67, and the surroundings of support stand 68. The air supplied from the blow port 66 to the surroundings of the wafer cassette 7 is returned to the fan motor 61 via the surroundings of the support stand 68. The air returned to the fan motor 61 is supplied again into the loader chamber 10b from the blow port 65, 66 via the filter boxes 63, 64 and the dustproof filters. In this way, the air in the loader chamber 10d is retained in a clean state by the local air-conditioning apparatus 60.

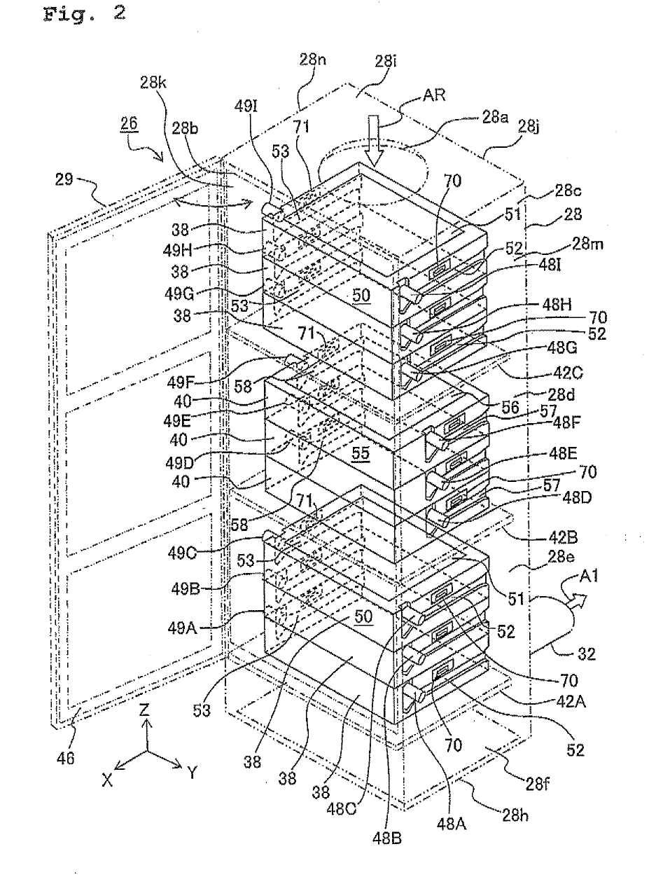

Next, an explanation will be made about the construction and the function of the filter apparatus 26 connected to the air-conditioning apparatus 30 in the overall air-conditioning system of this embodiment. The filter apparatus 26 has a slender box-shaped casing 28; partition plates 42A, 42B, 42C which divide the space in the casing 28 into four spaces; three stages of first filter boxes 38 which are installed and stacked on the upper surface of the partition plate 42A; three stages of second filter boxes 40 which are installed and stacked on the upper surface of the partition plate 42; and three stages of first filter boxes 38 which are installed and stacked on the upper surface of the partition plate 42C. In this embodiment, the casing 28 has a shape which is elongated or slender in the Z direction. The space in the casing 28 is divided into the four spaces in the Z direction, namely a first space 28c sandwiched or interposed by an upper plate 28i of the casing 28 and the partition plate 42C, a second space 28d interposed by the partition plate 42B and the partition plate 42C, a third space 28e interposed by the partition plate 42A and the partition plate 42B, and a fourth space 28f interposed by the partition plate 42A and a bottom plate 28h of the casing 28. Further, the filter apparatus 26 has a door 29 which is installed openably/closably to the casing 28 via hinge mechanisms (not shown) disposed at a plurality of positions in order that the window is opened to take in/out the filter boxes 38, 40 during the exchange of the filter boxes 38, 40. Here, a side of the window of the casing 28 which is closed by the door 28 is referred to as a “front surface 28k” of the casing 28, and a side (far side or rear side) facing or opposite to the window of the casing 28 is referred to as a “back surface 28j” of the casing 26, and two surfaces laterally connecting the front surface 28k and the back surface 28j are referred to as “side surfaces 28m, 28n” of the casing 28. An opening 28a (see FIG. 2) is formed through the upper plate 28i of the casing 28. An end portion of the piping 25 for introducing the air-conditioning air AR is fixed to the upper plate 28i. The first duct 32 is connected to the fourth space 28f which is the lowermost space of the casing 28.

FIG. 2 shows the filter apparatus 26 in a state that the door 29 of the casing 28 shown in FIG. 1 is open. In FIG. 2, the casing 28 and the door 29 are depicted by two-dot chain lines for the convenience of explanation. A chemical filter 51, which removes the organic gas (gas of organic matter), is retained or held in a box-shaped (rectangular frame-shaped) frame 50 having open upper and lower portions respectively in relation to each of the three stages of filter boxes 38 stacked on the upper surface of the lowermost stage partition plate 42A and the three stages of filter boxes 38 stacked on the upper surface of the uppermost stage partition plate 42C in the casing 28 shown in FIG. 2. A chemical filter 56, which removes the acid gas (gas of acid substance) and the alkaline gas (gas of alkaline substance) including ammonia, amine, etc. is retained or held in a box-shaped (rectangular frame-shaped) frame 55 having open upper and lower portions respectively in relation to each of the three stages of filter boxes 40 stacked on the upper surface of the middle stage partition plate 42B.

Each of the filter boxes 38, 40 has a height of for example, 200 to 400 mm, and each of the filter boxes 38, 40 has a weight of about 10 to 20 kg.

Those usable as the chemical filter 51 for removing the organic gas include, for example, activated carbon type filters and ceramics type filters. Those usable as the chemical filter 56 for removing the alkaline gas and the acid gas include impregnated activated carbon type filters, ion exchange resin type filters, ion exchange fiber type filters, impregnated ceramics type filters, and the like. Each of the frames 50, 55, the partition plates 42A to 42C, the casing 28, and the door 29 is formed of, for example, a material which has the corrosion resistance and which scarcely undergoes the degassing or the like, for example, stainless steel or aluminum (aluminum subjected to the almite treatment or processing) formed with an oxide coating (aluminum oxide or the like) on the surface. Each of the frames 50, 55, etc. can be also formed of, for example, a material including a resin material which has the corrosion resistance and which scarcely undergoes the degassing (laminated plate coated with polyethylene or fluorine-based resin, etc.).

By removing the organic gas, the transmittance of the exposure light EL is improved in the exposure chamber 10a of the chamber 10, and the appearance of the cloudiness substance is suppressed, which would be otherwise formed on the surface of the optical element on account of the interaction between the organic gas and the exposure light EL. Further, by removing the alkaline gas and the acid gas, the change in the characteristic of the photoresist of the wafer W, etc. is suppressed. In particular, in a case that the photoresist is the chemical amplification type photoresist, if any alkaline gas such as ammonia, amine or the like is present in the air, then it is feared that the produced acid might react to form a hardly soluble layer on the surface of the photoresist. Therefore, it is especially effective to remove the alkaline gas such as ammonia, amine or the like.

The chemical filters, which are accommodated in the filter boxes 63, 64 in the loader chamber 10b shown in FIG. 1, are constructed in the same manner as the chemical filters 51, 56. However, the filter boxes 63, 64 are small-sized as compared with the filter boxes 38, 40.

With reference to FIG. 2, protrusions/recesses are formed by guide grooves (first protrusion/recess-formed portions) 52, 53 on the both side surfaces in the longitudinal direction (Y direction) of each of the frames 50 of the six filter boxes 38 in total disposed on the partition plates 42A, 42C.

In this embodiment, the guide grooves 52, 53 are directly formed on the side surfaces of the frame 50. Therefore, the side surfaces of the frame 50 function as guide surfaces for loading or transporting the filter box 38 into the casing 28 at a predetermined position in the casing 28. Grip portions 70, 71, each of which is formed of a recess to be gripped by an operator manually or by hand, are attached to portions disposed over or above the guide grooves 52, 53 on the both side surfaces of the frame 50. A forward end portion of each of columnar shaft members (guides) 48A, 48B, 48C, 48G, 48H, 48I which are fixed to the inner surface of the casing 28 respectively is engaged with the guide groove 52 disposed on one side surface of one of the filter boxes 38; and a forward end portion of each of columnar shaft members 49A, 49B, 49C, 49G, 49R, 49I which are fixed to the inner surface of the casing 28 respectively is engaged with the guide groove 53 disposed on the other side surface of one of the filter boxes 38. The frames 50 of the filter boxes 38 are positioned in the X direction (short side direction) and the Y direction by the shaft members 48A, 49A, 49C, 49G, 49H, 49I, respectively.

The frames 50 of the lower stage filter boxes 38 are fixed by the self-weights in a state of being positioned with respect to the upper surfaces of the partition plates 42A, 42C. The frames 50 of the middle stage filter boxes 38 are positioned with respect to the upper end surfaces of the lower stage filter boxes 38, and are fixed by the self-weights. Further, the frames 50 of the upper stage filter boxes 38 are positioned with respect to the upper end surfaces of the middle stage filter boxes 38, and are fixed by the self-weights.

Similarly, protrusions/recesses are formed by guide grooves (second protrusion/recess-formed portions) 57, 58 on the both side surfaces in the longitudinal direction (Y direction) of each of the frames 55 of the three filter boxes 40 disposed on the partition plate 42B. In this embodiment, the guide grooves 57, 58 are directly formed on the side surfaces of the frame 55. Therefore, the side surfaces of the frame 55 function as guide surfaces for loading or transporting the filter box 40 into the second space 28d at a predetermined position in the casing 28. Grip portions 70, 71 are attached to portions disposed over or above the guide grooves 57, 58 on the both side surfaces of the frame 55. The forward end portion of each of columnar shaft members 48D, 48E, 48F fixed to the inner surface of the casing 28 respectively is engaged with the guide groove 57 disposed on one side surface of one of the filter boxes 40. The forward end portion of each of columnar shaft members 49D, 49E, 49F fixed to the inner surface of the casing 28 respectively is engaged with the guide groove 58 disposed on the other side surface of one of the filter boxes 40. The frames 55 of the three filter boxes 40 are fixed by the self-weights by the shaft members 48D, 49D, 48E, 49E, 48F, 49F in a state of being positioned in the X direction and the Y direction. The frame 55 of the lower stage filter box 40 is fixed by the self-weight in a state of being positioned with respect to the upper surface of the partition plate 42B. The frame 55 of the middle stage filter box 40 is positioned with respect to the upper end surface of the lower stage filter box 40, and is fixed by the self-weight. Further, the frame 55 of the upper stage filter box 40 is positioned with respect to the upper end surface of the middle stage filter box 40, and is fixed by the self-weight.

In this, case, the frame 50 of the filter box 38 and the frame 55 of the filter box 40 have the same outer shape (same outer dimension), and are different from each other only in the shapes of the guide grooves 52, 53 and the guide grooves 57, 58 formed on the both side surfaces in the Y direction. Further, the shaft members 48A to 48C, 48G to 48I, 49A to 49C and 49G to 49I have the distances from the front surface 28k of the casing 28 which are set to be shorter than the distances from the front surface 28k of the casing 28 which are provided for the shaft members 48D to 48F and 49D to 49F. Accordingly, the filter box 40, which has the chemical filter 56 for removing the alkaline gas and the acid gas, is prevented from being installed on the partition plates 42A, 42C; and reversely, the filter box 38, which has the chemical filter 51 for removing the organic gas, is prevented from being installed on the partition plate 42B.

A rectangular window 28b is formed on the front surface 28k of the casing 28 in order to take in/out the filter boxes 38, 40. A gasket 46 is fixed to the door 29 in order to hermetically close a space between the door 29 and the end portions of the partition plates 42B, 42C and the surroundings of the window 28b when the window 28b of the casing 28 is closed by the door 29. The gasket 46 can be formed of a material which is excellent in the corrosion resistance and which scarcely undergoes the degassing, including, for example, a sheet of Teflon (trade name of DuPont), a sheet of silicone rubber, etc.

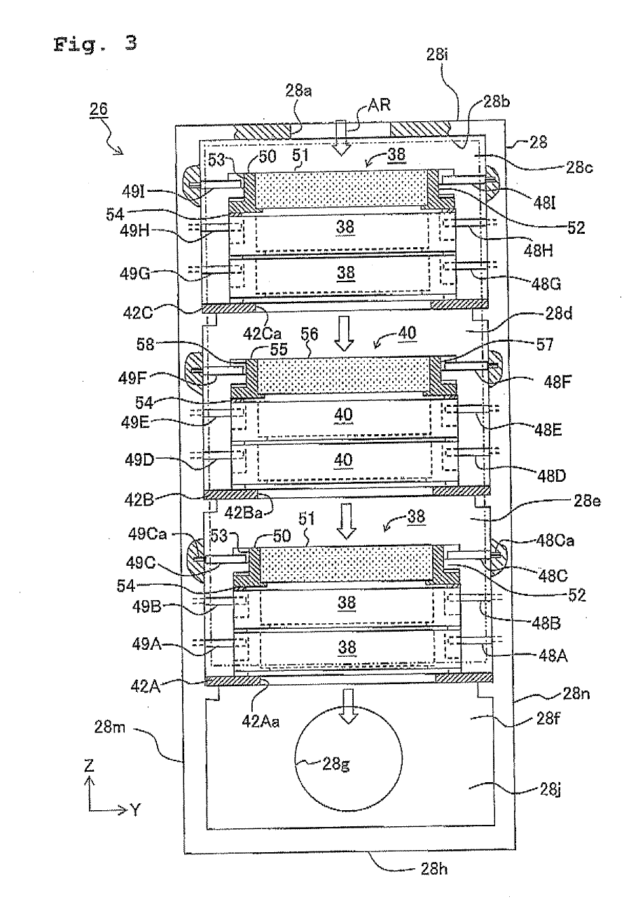

In the next viewpoint, FIG. 3 shows the casing 28 shown in FIG. 2 with partial cutaway as viewed from the front surface (forward surface) thereof. With reference to FIG. 3, openings 42Aa, 42Ba, 42Ca, through which the air AR having passed through the filter boxes 38, 40 is allowed to pass, are formed on the partition plates 42A to 42C respectively. A rectangular frame-shaped gasket 54 (sealing member disengageable from the installing surface), which is provided to enhance the gas-tightness with respect to the placing surface, is fixed to each of the bottom surfaces of the frames 50 of the filter boxes 38 and the frames 55 of the filter boxes 40. The material of the gasket 54 can be formed of a material which is excellent in the corrosion resistance and which scarcely undergoes the degassing, including, for example, a sheet of Teflon (trade name of Dupont), a sheet of silicone rubber, etc. Note that the material of the gasket 54 may be the same as or equivalent to the material of the gasket 46. As a result, the gas, in the first space 28c interposed between the partition plate 42C and the upper plate formed with the opening 28a of the casing 28, passes through the chemical filters 51 of the three stages of the filter boxes 38, and then the gas passes through the opening 42Ca to flow into the second space 28d interposed between the partition plates 42B, 42C. Similarly, the gas, in the second space 28d, passes through the chemical filters 56 of the three stages of the filter boxes 40, and then the gas passes through the opening 42Ba to flow into the third space 28e interposed between the partition plates 42A, 42B. Similarly, the gas, in the third space 28e, passes through the chemical filters 51 of the three stages of the filter boxes 38, and then the gas passes through the opening 42Aa, the fourth space 28f interposed by the partition plate 42A and the bottom surface of the casing 28, and an opening 28g disposed on the back surface (bottom surface) of the casing 28, and flows to the first duct 32 shown in FIG. 2. Therefore, the air AR, which is allowed to inflow from the opening 28a disposed at the upper portion of the casing 28, necessarily passes through the three stages of the filter boxes 38 for removing the organic gas, the three stages of the filter boxes 40 for removing the alkaline gas and the acid gas, and the three stages of the filter boxes 38 for removing the organic gas, and the air AR is supplied to the air-conditioning apparatus 30 shown in FIG. 1. Therefore, the air, from which the impurities have been removed to a high extent, is supplied into the chamber 10.

As shown in FIG. 3, the shaft members 48A to 48I, 49A to 49I are fixed to the side surfaces (inner sides) of the casing 28 respectively by screw portions 48Ca, 49Ca as representatively illustrated by the shaft members 48C, 49C.

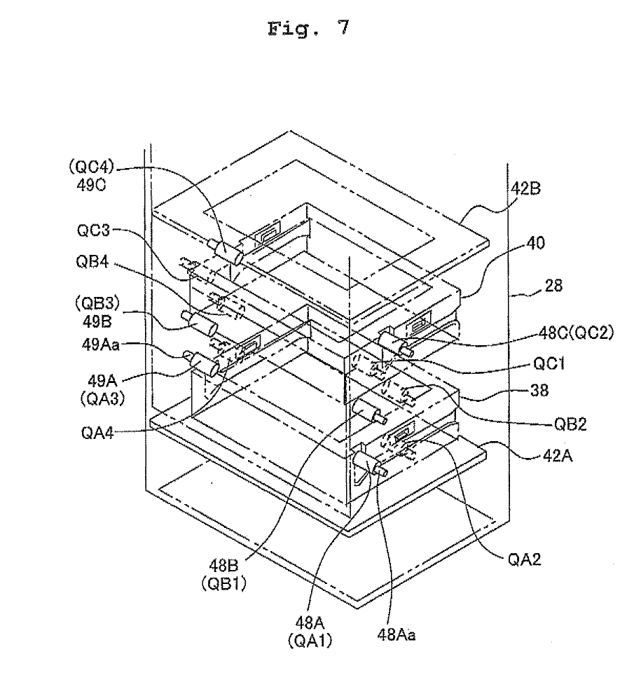

Further, as shown in FIG. 7, screw holes (not shown) are formed respectively on the both side surfaces between the partition plates 42A, 42B of the casing 28 at positions QA1, QB1, QC1 and QA3, QB3, QC3 corresponding to the shaft members 48A to 48C and 49A to 49C shown in FIG. 2 and positions QA2, QB2, QC2 and QA4, QB4, QC4 corresponding to the positions of the shaft members 48D to 48F and 49D to 49F in the X direction. Therefore, each of the shaft members 48A to 48C and 49A to 49C can be selectively fixed at any one of the positions QA1 or QA2, QB1 or QB2, QC1 or QC2 and the positions QA3 or QA4, QB3 or QB4, QC3 or QC4. In other words, the distances of the shaft members 48A to 48C and 49A to 49C from the front surface 28k of the casing 28 are adjustable.

In this case, by fixing the shaft members 48A to 48C and 49A to 49C at the positions QA1 to QC1 and the positions QA3 to QC3, the filter boxes 38 for removing the organic gas can be installed therebetween. On the other hand, by fixing the shaft members 48A to 48C and 49A to 49C at the positions QA2 to QC2 and the positions QA4 to QC4, the filter boxes 40 for removing the alkaline gas and the acid gas can be installed therebetween. Similarly, the configuration is also made for the other shaft members 48D to 48I and 49D to 49I shown in FIG. 3 so that the distances from the front surface 28k of the casing 28 are adjustable depending on the filter boxes 38, 40 to be installed.

With reference to FIG. 3, the spaces, which enable the operator to insert the hands, are secured between the both inner side surfaces of the casing 28 and the side surfaces in the Y direction of the filter boxes 38, 40. Accordingly, when the filter boxes 38, 40 are loaded and unloaded, the operator can move the filter boxes 38, 40 by gripping the grip portions 70, 71 disposed on the side surfaces of the filter boxes 38, 40, by the hands, in the casing 28 shown in FIG. 2.

Next, an explanation will be made about the shapes of the guide grooves 52, 53 of the frame 50 of the filter box 38 and the guide grooves 57, 58 of the frame 55 of the filter box 40. Here, regarding the frame 50 of the filter box 38, when the filter box 38 (frame 50) is inserted in the casing 28, a surface of the frame 50 which faces or is opposite to the front surface 28k of the casing 28 is referred to as a front surface 50a (first surface) of the frame 50; a surface facing the back surface 28j of the casing 28 is referred to as a back surface 50b (second surface) of the frame 50; and surfaces facing the side surfaces 28m, 28n of the casing 28 are referred to as side surfaces 50c, 50d (third and fourth surfaces) of the frame 50. In the embodiment, although the side surfaces 50c, 50d of the frame 50 are perpendicular to the front surface 50a and the back surface 50b, there is no limitation to the perpendicularity. For example, at least one of the front surface 50a and the back surface 50b of the frame 50 may intersect or cross (incline with respect to 90 degrees) with respect to the sides surfaces 50c, 50d of the frame 50. A surface of the frame 50 located above (on the upper side) with respect to the front surface 50a and the back surface 50b is referred to as an upper surface 50f; and a surface of the frame 50 located below (on the lower side) with respect to the front surface 50a and the back surface 50b is referred to as a bottom surface 50e. The respective surfaces of frame 55 of the filter box 40, which will be described later on, are also specified in a similar manner as regarding the frame 50 of the filter box 38.

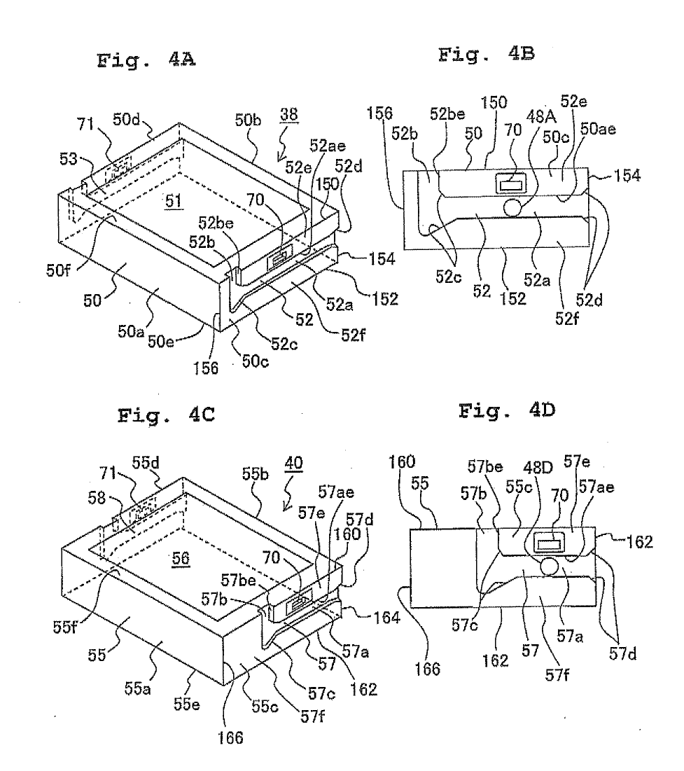

As shown in FIG. 4A, the guide grooves (first protrusion/recess-formed portions) 52, 53 are formed on the pair of side surfaces 50c, 50d in the longitudinal direction of the frame 50 of the first filter box 38. The guide groove 52 has a first groove (first recess) 52a which is arranged between an upper end 150 and a lower end 152 of the side surface 50c of the frame 50 and which is communicated with a back-side end 154 or the back surface 50b of the frame 50; and a second groove (second recess) 52b which is communicated with the first groove 52a and which extends toward the upper end 150 of the frame 50 (in a direction toward the upper surface 50f). The side surface 50c is divided by the guide groove 52 into an upper side portion 52e and a lower side portion 52f. The first groove (lateral recess) 52a is formed between the bottom surface 50e and the upper surface 50f of the frame 50 so that the first groove 52a extends in the lateral direction (X direction) along the bottom surface 50e and the upper surface 50f, and the second groove (vertical recess) 52b is formed between a front-side end 156 and the back-side end 154 of the frame 50, namely between the front surface 50a and the back surface 50b of the frame 50 so that the second groove 52b extends in the vertical direction (Z direction) along the front and back surfaces 50a and 50b.

Further, the guide groove 52 has a first tapered portion 52c which is formed at a position of communication between the first groove 52a and the second groove 52b and which has a width gradually narrowed from the side of the front surface 50a of the frame 50 toward the side of the back side end 154 or toward the side of the back surface 50b of the frame 50, and a second tapered portion 52d which is formed at a portion of communication with the back surface 50b of the first groove 52a and which has a width gradually widened toward (narrowed in a direction away from) the side of the back surface 50b, from the side of the front surface 50a of the frame 50. An edge portion 50ae (lower end portion of the upper side portion 52e, of the side surface 52d, divided by the guide groove 53) disposed on the side of the upper surface 50f of the first groove 52a and an edge portion 50be (side end portion of the upper side portion 52e, of the side surface 52d, divided by the guide groove 53) disposed on the side of the back surface 50b of the second groove 52b are connected by the first tapered portion 52c.

As shown in a side view of FIG. 4B, the widths of the first groove 52a and the second groove 52b are set to be somewhat or slightly wider than the diameter of the shaft member 48A provided in the casing 28 shown in FIG. 2. Accordingly, the shaft member 48A can be relatively moved (can be slidably moved) with respect to the frame 50 smoothly between the back surface 50b and the upper surface 50f of the frame 50 along the guide groove 52.

Note that since the shape of the guide groove 53 on the other side surface 50d of the frame 50 is symmetrical to the guide groove 52 with respect to the center line (not shown in the drawings) in the front and back direction of the frame 50 (in the description, referred to simply as “symmetrical”) or has a same shape as that of the guide groove 52, the explanation for the guide groove 53 will be omitted.

On the other hand, as shown in FIG. 4C, the guide grooves (second protrusion/recess-formed portions) 57, 58 are formed on a pair of side surfaces 55c, 55d in the longitudinal direction of the frame 55 of the second filter box 40. The side surface 55c is divided by the guide groove 57 into a first portion (small portion) 57e and a second portion (large portion) 57f. The guide groove 57 has a first groove 57a (third recess) which is arranged between an upper end 160 and a lower end 162 of the side surface 55c of the frame 55 and which is communicated with a back side end 164 or a back surface 55b of the frame 55; and a second groove 57b (fourth recess) which is communicated with the first groove 57a and which extends toward the upper end of the frame 55 (in a direction toward an upper surface 55f). The first groove 57a is formed between the bottom surface 55e and the upper surface 55f of the frame 55, and the second groove 57b is formed between the back side end 164 and a front side end 166 of the side surface 55, namely between a front surface 55a and the back surface 55b of the frame 55. The distance of the second groove 57b with respect to the front surface 55a of the frame 55 of the filter box 40 is set to be longer than the distance of the second groove 52b with respect to the front surface 50a of the frame 50 of the filter box 38. The difference in the distance between the guide groove 52b and the second groove 57b is the same as the distance in the X direction between the shaft member 48A and the shaft member 48D shown in FIG. 2.

Further, the guide groove 57 also has a first tapered portion 57c which is formed at a position of communication between the first groove 57a and the second groove 57b and which has a width gradually narrowed toward the back surface 55b of the frame 55, and a second tapered portion 57d which is formed at a portion of communication with the back surface 55b of the first groove 57a and which has a width gradually widened toward the back surface 55b. An edge portion 57ae (the lower end portion of the first portion 57e) disposed on the side of the upper surface 55f of the first groove 57a and an edge portion 57be (the side end portion of the first portion 57e) disposed on the side of the back surface 55b of the second groove 57b are connected by the first tapered portion 57c.

As shown in a side view of FIG. 4D, the widths of the first groove 57a and the second groove 57b are set to be somewhat or slightly wider than the diameter of the shaft member 48D provided in the casing 28 shown in FIG. 2. Accordingly, the shaft member 48D can be relatively moved (slidably movable) with respect to the frame 55 smoothly between the back surface 55b and the upper surface 55f of the frame 55 along the guide groove 57.

The frames 50, 55 can be produced by, for example, the mold molding or mold forming. Note that since the shape of the guide groove 58 on the other side surface 50d of the frame 55 is symmetrical to the guide groove 57 with respect to the center line (not shown in the drawings) in the front and back direction of the frame 55 (or has a same shape as that of the guide groove 57), the explanation for the guide groove 58 will be omitted.

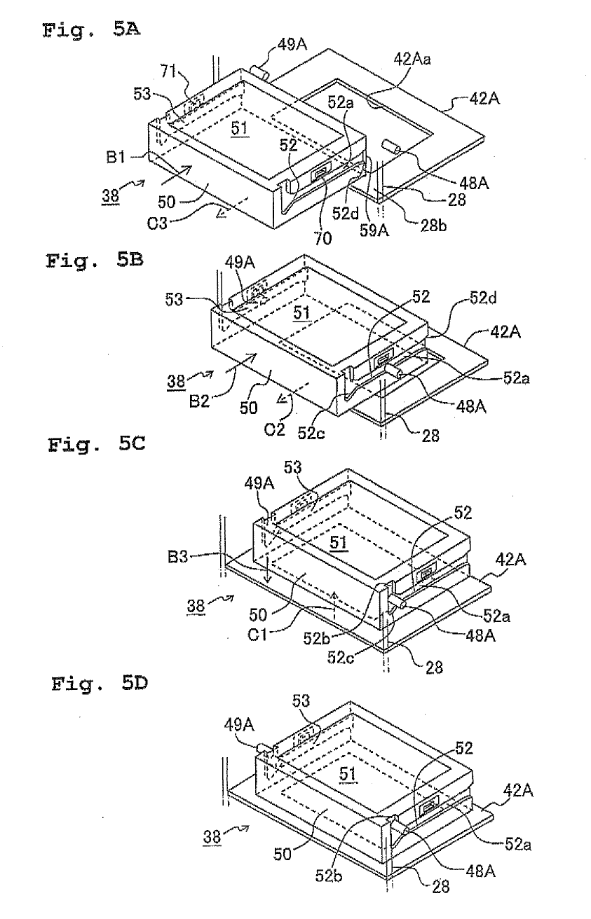

Next, in a case that the filter box 38 shown in FIG. 4A is installed or arranged on the upper surface of the partition plate 42A of the casing 28 shown in FIG. 2, as shown in FIG. 5A, the operator moves the first groove 52a and the equivalent of the guide grooves 52, 53 of the filter box 38 (frame 50) to the positions located in front of the pair of shaft members 48A, 49A of the casing 28 in a state that the filter box 38 is held via the grip portions 70, 71 of the frame 50.

In an unused filter box 38, a thin film 59A is provided in a stretched form at the inlet of the first groove 52a of the frame 50 so that the thin film 59A can be exfoliated. The filter box 38 is pushed and inserted into the casing 28 via the window 28b as shown by an arrow 81, and the filter box 38 is further pushed and inserted so that the shaft member 48A is relatively moved slidably with respect to the frame 50 along the first groove 52a as shown by an arrow B2 in FIG. 5B. By doing so, the film 59A is exfoliated. Therefore, when the filter box 38 is unloaded in the next time, it is possible to confirm that the filter box 38 has been used. Further, the edge portions, which are disposed at the upper ends of the first groove 52a and the equivalent of the frame 50, are moved along the shaft members 48A, 49A. Therefore, even when the weight of the filter box 38 is large, the filter box 38 can be easily pushed and inserted into the casing 28.

After that, as shown in FIG. 5C, the second groove 52b of the filter box 38 arrives at the shaft member 48A, and then the filter box 38 is lowered to be placed on the upper surface of the partition plate 42A as shown by an arrow 83 so that the shaft member 48A is relatively moved with respect to the frame 50 along the second groove 52b by the self-weight of the filter box 38. As a result, as shown in FIG. 5D, the filter box 38 is placed on the partition plate 42A in a state that the shaft members 48A, 49A are stopped at the into intermediate positions of the second groove 52b and the equivalent of the guide grooves 52, 53. Accordingly, the filter box 38 is placed stably in a state that the filter box 38 is correctly positioned in the X-Y direction to cover the opening 42Aa of the partition plate 42A therewith.

Further, owing to the presence of the second tapered portion 52d, the first groove 52a can be easily guided and engaged with the shaft member 48A. Further, owing to the presence of the first tapered portion 52c, the second groove 52b can be easily engaged with the shaft member 48A next to the first groove 52a of the guide groove 52. By the first tapered portion 52c, the operator is enabled to easily grasp the position of the second guide groove 52b, consequently the position of the install position (arrangement position) in the inserting direction (X-direction) of the filter box 38.

The other filter boxes 38 shown in FIG. 2 can be also placed on the upper surface of the filter box 38 or the upper surface of the partition plate 42C in the same manner as described above.

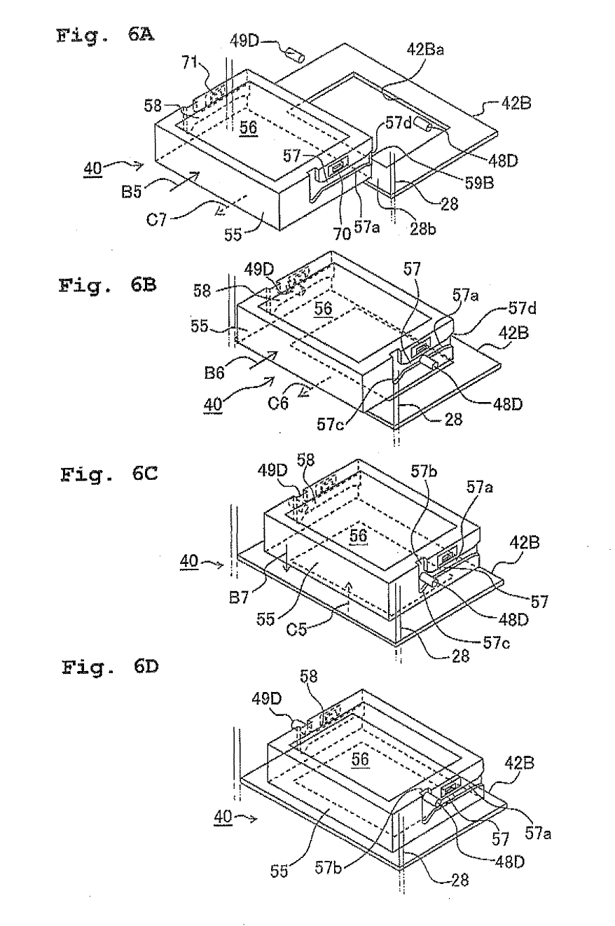

On the other hand, in a case that the filter box 40 shown in FIG. 4C is installed or arranged on the upper surface of the partition plate 42B of the casing 28 shown in FIG. 2, as shown in FIG. 6A, the operator moves the first groove 57a and the equivalent of the guide grooves 57, 58 of the filter box 40 (frame 55) to the positions located in front of the pair of shaft members 48D, 49D of the casing 28 in a state that the filter box 40 is held via the grip portions 70, 71 of the frame 55. In an unused filter box 40, a thin film 59B is provided in a stretched form at the inlet of the first groove 57a so that the thin film 59B can be exfoliated. The filter box 40 is pushed and inserted into the casing 28 via the window 28b as shown by an arrow B5 to engage the first groove 57a with the shaft member 48D, and thus the film 59B is exfoliated.

Subsequently, as shown by an arrow B6 in FIG. 6B, the filter box 40 is further slidably pushed and inserted. By doing 80, as shown in FIG. 6C, the second groove 57b of the filter box 40 arrives at the shaft member 48D. Also in this case, the edge portions, which are disposed at the upper ends of the first groove 57a and the equivalent of the frame 55, are moved along the shaft members 48D, 49D. Therefore, even when the weight of the filter box 40 is large, the filter box 40 can be easily pushed and inserted into the casing 28. After that the filter box 40 is placed on the upper surface of the partition plate 42B so that the shaft member 48D is relatively moved with respect to the frame 55 along the second groove 57b as shown by an arrow 57. As a result, as shown in FIG. 6D, the filter box 40 is placed on the partition plate 42B in a state that the shaft members 48D, 49D are positioned at the intermediate positions of the second groove 57b and the equivalent of the guide grooves 57, 58. Accordingly, the filter box 40 is placed stably in a state that the filter box 40 is correctly positioned in the X-Y direction, to cover the opening 42Ba of the partition plate 42B therewith.

The remaining filter boxes 40 shown in FIG. 2 can be also placed on the upper surfaces of the other filter boxes 40 in the same manner as described above. After that, the door 29 shown in FIG. 2 is closed, and thus the filter apparatus 26 can be used. The clean air, which is allowed to pass through the filter apparatus 26, can be supplied into the chamber 10 of the exposure apparatus EX.

Next, in a case that the filter boxes 38, 40 of the filter apparatus 26 are exchanged, the door 29 of the casing 28 is opened. The upper stage filter box 38 placed or disposed on the middle stage filter box 38 is unloaded from the middle stage filter box 38. After that, the middle stage filter box 38 placed on the lower stage filter box 38 is unloaded from the lower stage filter box 38. Finally, the lower stage filter box 38 placed or disposed on the partition plate 42A is unloaded from the partition plate 42A. The operations for unloading the filter boxes of the upper stage, the middle stage, and the lower stage are same with each other. Therefore, the unloading operation will be specifically explained below as exemplified by an exemplary case in which the lower stage filter box 38 is unloaded from the partition plate. After the upper stage filter box 38 and the middle stage filter box 38 are unloaded, the lower stage filter box 38 is unloaded according to an unloading method which will be explained below. When the lower stage filter box 38 is unloaded from the partition plate 42A, the operator grips the grip portions 70, 71 of the filter box 38 by the hands, and the operator lifts (uplifts) the filter box 38 upwardly so that the shaft member 48A is relatively moved with respect to the frame 50 slidably along the second groove 52b of the guide groove 52 as shown by an arrow C1 in FIG. 5C. Then, after the first tapered portion 52c of the guide groove 52 arrives at the shaft member 48A, the filter box 38 is pulled and extracted in the frontward direction (in the direction directed toward the front surface of the filter box 38) so that the shaft member 48A is relatively moved with respect to the frame 50 slidably along the first groove 52a as shown by an arrow C2 in FIG. 5B. Also in this case, the weight of the filter box 38 is supported by the shaft members 48A, 49A. Therefore, the filter box 38 can be easily pulled and extracted. After that, as shown by an arrow C3 in FIG. 5A, the filter box 38 is further pulled and extracted in the frontward direction in relation to the casing 28, and thus the filter box 38 can be unloaded. In this procedure, owing to the presence of the first tapered portion 52c of the guide groove 52, the movement can be performed smoothly from the second groove 52b to the first groove 52a of the guide groove 52 along the shaft member 48A.

Similarly, the other filter boxes 38 can also be unloaded easily. After that, when an unused filter box is installed or arranged in the casing 28, the operation from FIGS. 5A to 5D may be repeated.

Further, for example, when the filter box 40 is unloaded from the upper surface of the partition plate 42B, the operator grips the grip portions 70, 71 of the filter box 40 by the hands, and lifts the filter box 40 upwardly so that the shaft member 48D is relatively moved with respect to the frame 55 slidably along the second groove 57b of the guide groove 57 as shown by an arrow C5 in FIG. 6C. Then, after the first tapered portion 57c of the guide groove 57 arrives at the shaft member 48D, the filter box 40 is pulled and extracted in the frontward direction so that the shaft member 48D is relatively moved with respect to the frame 55 slidably along the first groove 57a as shown by an arrow C6 in FIG. 6B. After that, as shown by an arrow C7 in FIG. 6A, the filter box 40 is further pulled and extracted in the frontward direction in relation to the casing 28, and thus the filter box 40 can be unloaded.

Similarly, the other filter boxes 40 can also be easily unloaded. After that, when an the unused filter box 40 is installed or arranged in the casing 28, the operation ranging from FIG. 6A to FIG. 60 may be repeated.

The effects, etc. of this embodiment are as follows.

(1) The exposure apparatus EX of this embodiment is provided with the overall air-conditioning system including the filter apparatus 26 and the air-conditioning apparatus 30.

The filter apparatus 26 (filter holding apparatus) is provided, with the filter box 38 and the filter box 40 which hold the chemical filter 51 (first filter) and the chemical filter 56 (second filter) respectively. Namely, the filter apparatus 26 includes the box-shaped frame (first frame) 50 which holds the chemical filter 51 and which is provided with the guide grooves (first protrusion/recess-formed portions) 52, 53 provided on the pair of side surfaces 50c, 50d of the frame 50; and the box-shaped frame (second frame) 55 which holds the chemical filter 56, which has the guide grooves (second protrusion/recess-formed portions) 57, 58 provided on the pair of side surfaces 55c, 55d of the frame 55, and which is arranged while being overlapped with the frame 50 in the casing 28 (container). Further, the guide groove 52 of the frame 50 has the first groove (first recess) 52a which is communicated with the back surface 55 of the frame 50, and the second groove (second recess) 52b which is communicated with the first groove 52a and which extends toward the upper end of the frame 50; the guide groove 57 of the frame 55 has the first groove (third recess) 57a which is communicated with the back surface 55 of the frame 50, and the second groove (fourth recess) 57b which is communicated with the first groove 57a and which extends toward the upper end of the frame 55; and the positional relationship of the second groove 52b with respect to the first groove 52a and the positional relationship of the second groove 57b with respect to the first groove 57a are different from each other.

The guide grooves 52, 53 have the symmetrical or same shapes; and the guide grooves 57, 58 have the symmetrical or same shapes.

The phrase “the frame 50 and the frame 55 are arranged in the casing 28 while being overlapped with each other” means that the frame 50 and the frame 55 are arranged along the flow of the gas to be subjected to the filtration, and thus includes not only a case that the frames 50 and 55 are directly brought into contact with each other and stacked and overlaid (overlapped) but also such a case that the frames 50 and 55 are overlapped and stacked with, for example, a plate in which a passage for a gas such as the partition plate 42C is formed is intervened between the frames 50 and 55.

According to the embodiment, by providing the shaft members 48A, 49A (first guide portions) on the side of the casing 28 accommodating the frames 50 and 55 and by moving the frames 50, 55 so that the shaft members 48D, 49D, etc are relatively moved with respect to frames 50, 55 along the guide grooves 52, 57, etc. of the frames 50, 55 respectively, the frames 50, 55 can be efficiently installed to the casing 28 so that the positioning can be easily performed. Further, by moving the frames 50, 55 in the opposite direction, the frames 50, 55 can be efficiently unloaded from the casing 28. Accordingly, it is possible to efficiently exchange the plurality of frames 50, 55 (and consequently the chemical filters 51, 56) in the casing 28.

Further, the positional relationship of the second groove 52b with respect to the first groove 52a of the frame 50 and the positional relationship of the second groove 57b with respect to the first groove 57a of the frame 55 are different from each other. Therefore, in a case that the types of the chemical filters 51, 56 are different from each other as in this embodiment, the placement or installation positions for the chemical filters 51, 56 in the casing 28 are prevented from being mistaken.

(2) It is appropriate that the guide grooves 52, 53 and 57, 58 of the frames 50, 55 are formed substantially symmetrically or to have a substantially same shape respectively.

It is also allowable that each of the guide grooves 52, 57 is formed on only one side surface (for example, the side surface 50c, 55c) of one of the frames 50, 55. In this case, the other side surface 50d, 55d is a substantially flat surface. Further, the frames 50, 55 are moved so that the guide grooves 52, 57 each as one of the grooves are moved relative to and along the shaft members 48A, 48D, respectively. Accordingly, each of the frames 50, 55 can be arranged or placed in the casing 28 relatively easily. Further, each of the frames 50, 55 can be easily unloaded from the casing 28.

(3) Further, in the embodiment, the distance from the front surface 50a of the frame 50 to the second groove 52b on the upper surface 50f of the frame 50 (for example, the distance up to the edge portion 50be) and the distance from the front surface 55a of the frame 55 to the second groove 57b on the upper surface 55f of the frame 55 (for example, the distance up to the edge portion 57be) is different from each other by a predetermined distance ΔX. Accordingly, by making the distance from the window 28b to the shaft members 48A, 49A for the frame 50 be different from the distance from the window 28b to the shaft members 48D, 49D for the frame 55 on the side of the casing 28 by the distance ΔX, it is possible to prevent the frames 50, 55 from being installed erroneously at positions other than the intended target positions for the frames 50, 55 in the casing 28, with a simple construction.

(4) The guide grooves 52, 57 of the frames 50, 55 have the first tapered portions 52c, 57c which are formed at the positions of communication between the first grooves 52a, 57a and the second grooves 52b, 57b and which have the widths gradually narrowed toward the back surfaces of the frames 50, 55. Therefore, the shaft members 49A, 49D can be relatively moved smoothly with respect to the guide grooves 52, 57.

It is not necessarily indispensable that the first tapered portions 52c, 57c are provided.

(5) Further, the guide grooves 52, 57 have the second tapered portions 52d, 57d which are formed at the portions of communication with the back surfaces of the first grooves 52a, 57a and which have the widths gradually widened toward the back surfaces. Therefore, the first grooves 52a, 57a can be engaged with the shaft members 48A, 48D, while being guided, with ease. The second tapered portions 52d, 57d can be also omitted.

(6) Further, the grip portions 70, 71 (fifth recesses) are provided between the upper ends of the frames 50, 55 and the first grooves 52a, 57a and the equivalents of the frames 50, 55. Therefore, the operator, can transport the frames 50, 55 (filter boxes 38, 40) with ease. Each of the grip portions 70, 71 may be provided on only one side. For example, by making the side surfaces 50c, 50d and 55c, 55d of the frames 50, 55 be rough surfaces, it is also possible to omit the grip portions 70, 71.

(7) The films 59A, 59B are provided at the inlets of the first grooves 52a, 57a of the frames 50, 55 so that the films 59A, 59B can be exfoliated. Therefore, it is possible to easily confirm whether the chemical filters in the frames 50, 55 have been used or unused.

The films 59A, 59B may be provided beforehand at any portions of the first grooves 52a, 57a and the second grooves 52b, 57b. Whether or not the chemical filters have been used may be also confirmed by any other method (for example, a method in which the operator exfoliates a label) without providing the films 59A, 59B for the frames 50, 55.

(8) The chemical filter 51 (filter medium) in the frame 50 removes the organic gas (organic matter) contained in the gas passing therethrough, and the chemical filter 56 (filter medium) in the frame 55 removes the alkaline gas and the acid gas contained in the gas passing therethrough. Therefore, the air, from which the impurities have been removed to a high extent, can be supplied into the chamber 10 in which the exposure apparatus-body section 4 is accommodated.

Further, the six stages of the frames 50 (filter boxes 38) and the three stages of the frames 55 (filter boxes 40) are installed in the filter apparatus 26 of this embodiment. However, the number of the frame or frames 50 to be installed is arbitrary, and the number of the frame or frames 55 is arbitrary as well.

The casing 28 of the filter apparatus 26 is comparted or partitioned into the plurality of spaces by the partition plates 42A to 42C. However, it is also possible to simply stack the frames 50, 55 (filter boxes 38, 40), for example, alternately, without partitioning the space in the casing 28 by the partition plates 42A to 42C.

The chemical filter 56 in the frame 55 may be, for example, a filter which removes at least one of the alkaline substance and the acid substance contained in the gas passing therethrough.

Further, any arbitrary filter (filter medium) other than the chemical filter can be used for the filters in the frames 50, 55. For example, a dustproof filter such as HEPA filter, ULPA filter or the like, which is provided to remove minute particles (fine particles), can be also used as each of the filters in the frames 50, 55.

(9) The exposure apparatus EX of this embodiment is the exposure apparatus which exposes the wafer W (substrate) with the exposure light EL via the pattern of the reticle R and the projection optical system PL, the exposure apparatus EX including the chamber 10 accommodating the exposure apparatus-body section 4 which exposes the wafer W; the filter apparatus 26 of this embodiment; and the air-conditioning apparatus 30 which feeds the air taken in from the outside of the chamber 10 to the inside of the chamber 10 via the filter apparatus 26.

According to this embodiment, the filter box 38 (frame 50 which holds the chemical filter 51) and the filter box 40 (frame 55 which holds the chemical filter 56) can be installed and exchanged efficiently; and the positioning can be performed highly accurately between the frames 50, 55. Therefore, the maintenance can be performed efficiently for the exposure apparatus, and it is possible to highly accurately remove the impurities of the air in the chamber 10.

In this embodiment, frames, which are formed with the same or equivalent guide grooves as those of the frames 50, 55 of the filter boxes 38, 40, may be also used as the frames for the filter boxes 63, 64 of the local air-conditioning apparatus 60 in the loader chamber 10b, and the filter boxes 63, 64 may be also accommodated in a casing provided with shaft members 48A, 48B, 48D, 49D, etc. in the same manner as the casing 28.

In the first embodiment, although the guide grooves are formed on the side surfaces of the frame 50, the frame 50 may be formed with two distinct or separate members. For example, the frame 50 may be formed of a frame body which is formed to have flat side surfaces and which holds the filter, and a protrusion/recess-formed member which is attached to the side surfaces of the frame body and which has guide grooves formed therein.

### Second Embodiment

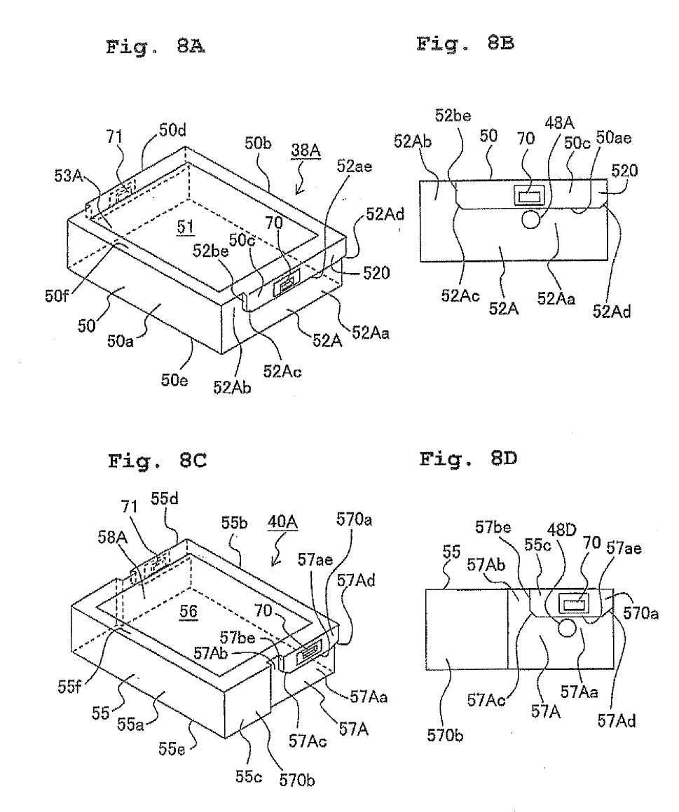

Next, a second embodiment of the present invention will be explained with reference to FIGS. 8 to 10. In this embodiment, the shapes of the guide grooves (protrusion/recess-formed portions) of the frame of the filter box are changed, and the other portions are the same as or equivalent to those of the first embodiment. In the following description, the components or parts, which correspond to those shown in FIGS. 4, 5, and 6, are designated by the same reference numerals in FIGS. 8, 9, 10, any detailed explanation of which will be omitted.

FIG. 8A shows a perspective view illustrating a filter box 38A which holds the chemical filter 51, and FIG. 8C shows a perspective view illustrating a filter box 40A which holds the chemical filter 56. The filter boxes 38A, 40A can be installed in the casing 28, instead of the filter boxes 38, 40 shown in FIG. 2 respectively.

As shown in FIG. 8A, guide grooves 52A, 53A (first protrusion/recess-formed portions) are symmetrically formed or formed to have a same shape on a pair of side surfaces 50c, 50d in the longitudinal direction of a frame 50 of the filter box 38A. The guide groove 52A has a first groove 52Aa (first recess) which is arranged between the upper end and the lower end of the side surface 50c of the frame 50, which is communicated with the back surface 50b of the frame 50, and which is spread to the lower end of the frame 50; and a second groove 52Ab (second recess) which is communicated with the first groove 52Aa, which extends toward the upper end of the frame 50, and which is spread to the front surface 50a of the frame 50.

In this embodiment, the first groove 52Aa is a portion which is formed while being recessed with respect to the side surface 50c of the frame 50. Therefore, the first groove 52Aa can be also referred to as “recess-formed portion”, and a portion 520 other than the guide groove 52A of the side surface 50c of the frame 50 can be also referred to as “protrusion-formed portion”.

Further, the guide groove 52A has a first tapered portion 52Ac which is formed at a position of communication between the first groove 52Aa and the second groove 52Ab and which has a width gradually narrowed toward the back surface 50b, and a second tapered portion 52Ad which is formed at a portion communicated with the back surface 50b of the first groove 52Aa and which has a width gradually widened toward the back surface 50b. An edge portion 50ea disposed on the upper surface side of the first groove 52Aa and an edge portion 50be disposed on the side of the back surface 50b of the second groove 52Ab are connected by the tapered portion 52Ac.

In this case, as shown in a side view of FIG. 8B, the widths of the first groove 52Aa and the second groove 52Ab are set to be wider than the diameter of the shaft member 48A provided in the casing 28 shown in FIG. 2. Note that since the shape of the guide groove 53 on the other side surface 50d of the frame 50 is symmetrical with or has a same shape as that of the guide groove 52, the explanation therefor will be omitted.

As shown in FIG. 8C, guide grooves (second protrusion/recess-formed portions) 57A, 57B are formed on a pair of side surfaces 55c, 55d of a frame 55 of the filter box 40A. The guide groove 57A has a first groove (third recess) 57Aa which is arranged between the upper end and the lower end of the side surface 55c of the frame 55, which is communicated with the back surface 55b of the frame 55, and which is spread to the lower end of the frame 55; and a second groove (fourth recess) 57Ab which is communicated with the first groove 57Aa and which extends toward the upper end of the frame 55. In this embodiment, the first groove 57Aa is a portion which is formed while being recessed with respect to the side surface 55c of the frame 55. Therefore, the first groove 57Aa can be also referred to as “recess-formed portion”, and the portion other than the guide groove 57A of the side surface 55c of the frame 55, namely a portion 570a which is partitioned by the first groove 57Aa and the second groove 57Ab and a portion 570b partitioned only by the second groove 57Ab, can be also referred to as “protrusion-formed portion”.

The distance of the edge portion 57be of the second groove 57Ab with respect to the front surface 55a of the frame 55 of the filter box 40A is set to be longer than the distance of the edge portion 52be of the second groove 52Ab with respect to the front surface 50a of the frame 50 of the filter box 38A.

Further, the guide groove 57A also has a first tapered portion 57Ac which is formed at a position of communication between the first groove 57Aa and the second groove 57Ab and which has a width gradually narrowed toward the back surface 55b of the frame 55, and a second tapered portion 57Ad which is formed at a portion communicated with the back surface 55b of the first groove 57Aa and which has a width gradually widened toward the back surface 55b.

As shown in a side view of FIG. 8D, the width of the first groove 57Aa is set to be wider than the diameter of the shaft member 48D, and the width of the second groove 57Ab is set to be somewhat or slightly wider than the diameter of the shaft member 48D. Accordingly, the shaft member 48D is relatively movable with respect to the frame 55 smoothly between the back surface 55b and the upper surface 55f of the frame 55 along the guide groove 57A.

Note that since the shape of the guide groove 58A on the other side surface 55d of the frame 55 is symmetrical with (or has a same shape as) that of the guide groove 57A, the explanation therefor will be omitted.

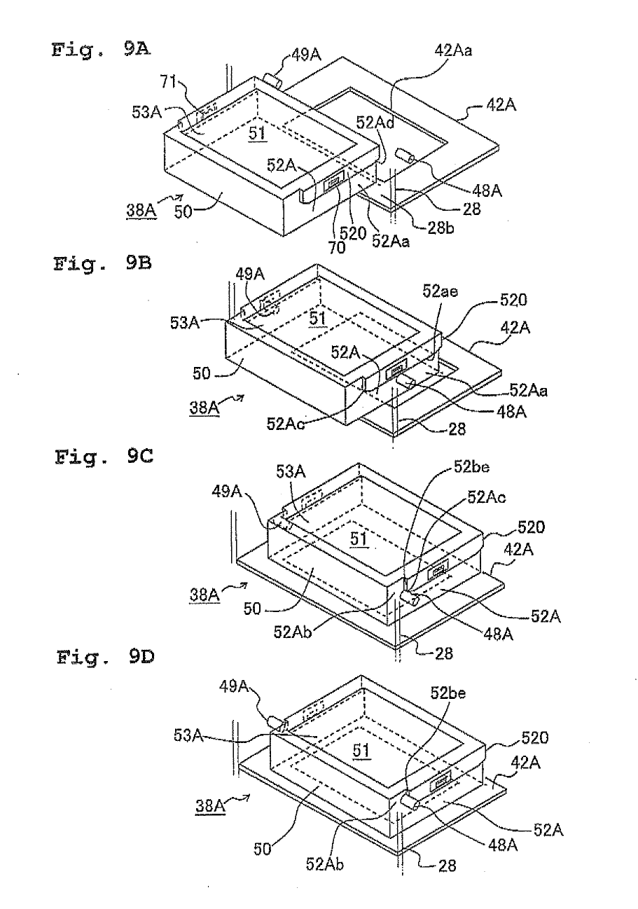

Next, in a case that the filter box 38A shown in FIG. 8A is installed on the upper surface of the partition plate 42A of the casing 28 shown in FIG. 2, the operator moves the first groove 52Aa and the equivalent of the guide grooves 52A, 53A of the filter box 38A (frame 50) to the positions located in front of the pair of shaft members 48A, 49A of the casing 28 in a state that the operator holds the filter box 38A via the grip portions 70, 71 of the frame 50 as shown in FIG. 9A.

The filter box 38A is pushed and inserted into the casing 28 via the window 28b. As shown in FIG. 9B, the filter box 38A is further pushed and inserted so that the shaft member 48A is relatively moved with respect to the frame 50 along the edge portion 52ae (the lower end of the portion 520) of the first groove 52Aa. After that, as shown in FIG. 9C, the second groove 52Ab of the filter box 38A arrives at the shaft member 48A, and then the filter box 38A (frame 50) is lowered so that the shaft member 48A is relatively moved with respect to the frame 55 along the edge portion 52be (the side end of the portion 520) of the second groove 52Ab to place the filter box 38A (frame 50) on the upper surface of the partition plate 42A. As a result, as shown in FIG. 9D, the filter box 38A is placed on the partition plate 42A in a state that the shaft members 48A, 49A are stopped at the intermediate positions of the second groove 52Ab and the equivalent of the guide grooves 52A, 53A. Accordingly, the filter box 38A is placed stably in a state that the filter box 38A is correctly positioned in the X-Y direction so as to cover the opening 42Aa of the partition plate 42A therewith.

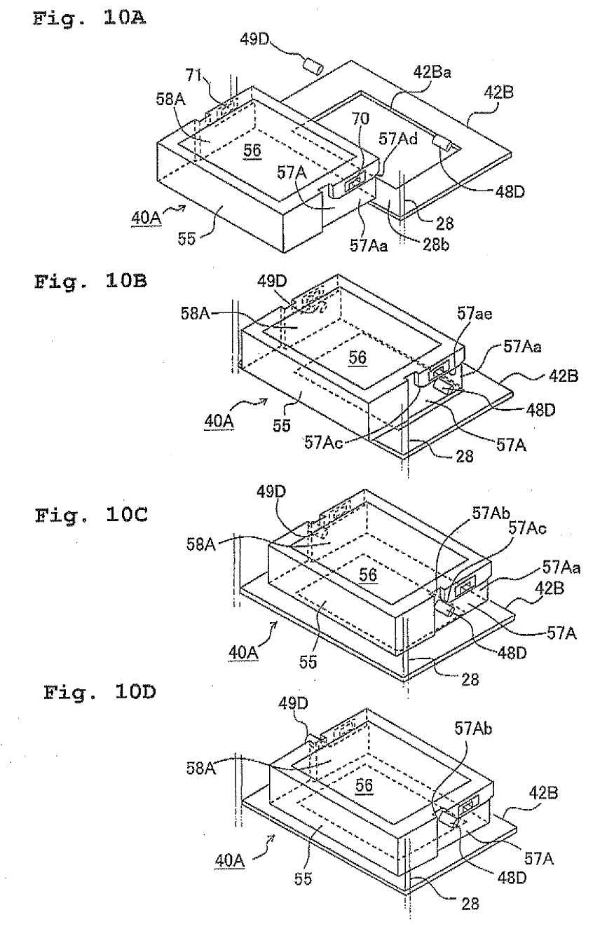

On the other hand, in a case that the filter box 40A shown in FIG. 8C is installed on the upper surface of the partition plate 42B of the casing 28 shown in FIG. 2, the operator moves the first groove 57Aa and the equivalent of the guide grooves 57A, 58A of the filter box 40A (frame 55) to the positions located in front of the pair of shaft members 48D, 49D of the casing 28 in a state that the operator holds the filter box 40A via the grip portions 70, 71 of the frame 55 as shown in FIG. 10A. The filter box 40A is pushed and inserted into the casing 28 via the window 28b, and the edge portion 57ae (the lower end of the portion 570a) of the first groove 57Aa is engaged with the shaft member 48D.

Subsequently, by further slidably pushing and inserting the filter box 40A as shown in FIG. 10B, the second groove 57Ab of the filter box 40A arrives at the shaft member 48D as shown in FIG. 10C. After that, the filter box 40A (frame 55) is lowered so that the shaft member 48D is relatively moved with respect to the frame 55 along the second groove 57Ab to place the filter box 40A (frame 55) on the upper surface of the partition plate 42B. As a result, as shown in FIG. 10D, the filter box 40A is placed on the partition plate 42B in a state that the shaft members 48D, 49D are positioned at the intermediate positions of the second groove 57Ab and the equivalent of the guide grooves 57A, 58A. Accordingly, the filter box 40A is placed stably in a state that the filter box 40A is correctly positioned in the X-Y direction to cover the opening 42Ba of the partition plate 42B therewith.

The frames 50, 55 (filter boxes 38A, 40A) can be easily unloaded from the partition plates 42A, 42B respectively in accordance with the operation of FIGS. 9D to 9A and the operation of FIGS. 10D to 10A. Therefore, the filter boxes 38A, 40A can be exchanged with ease.

The first embodiment is illustrative of the construction in which the guide grooves 52, 53 are directly formed on the side surfaces of the frame 50. However, another construction is also allowable, in which the guide grooves 52, 53 are formed on members distinct from the frame 50, and then the members are attached to the side surfaces of the frame 50. The other frame 55 may be constructed in the same manner as described above.

In the embodiment described above, an example is shown in which the second groove is formed to penetrate up to (penetrate to arrive at) the upper end of the frame. However, it is allowable that the second groove may be formed up to a position in front of (not arriving to) the upper end of the frame (the upper end of the second groove has a holding or stopping portion). By doing so, in a case that the user inadvertently makes a mistake regarding the installation position of the filter box in the up and down direction, it is possible to avoid the hand(s) of the user from being affected by a sudden load, owing to the presence of the holding portion at the upper end of the second groove. In the embodiment, the groove having a specific shape and the protrusion/recess-formed portion having a specific shape are shown by the drawings. However, the groove and the protrusion/recess-formed portion are not limited to the exemplified specific shapes, and may be formed to have any shapes. With respect to the shaft member, the shape of the shaft member is not limited to the columnar shape shown in the embodiment; and it is allowable to use shaft members having various shapes such as quadrangular prism shape, etc.

In the second embodiment, when the side surface 50c of the frame 50 is a protrusion-formed portion, the protrusion-formed portion may be formed with a distinct member. The other frame 55 may be constructed in the same manner as described above.

Further, in the respective embodiments described above, whether or not the filter box has been used is distinguished based on the exfoliation of the thin film. However, the present invention is not limited to this construction. It is also allowable that whether or not the filter box has been, used is distinguished based on whether or not any cutout is formed in the film.

In the embodiment described above, the filter boxes 38 and 40 are respectively installed or charged in the casing at appropriate positions one by one. It is allowable, however, to install a plurality of filter boxes such as two pieces or three pieces of the filter boxes in the casing at the same time while stacking or overlaying (overlapping) the filter boxes. In such a case, it is allowable for example that among two pieces (or three pieces) of the filter boxes, a filter box or filter boxes is/are previously positioned with respect to and arranged on a lowermost filter box among the filter boxes which is located at the lowermost position, and then these filter boxes are installed or charged in the cashing. By doing so, when only the filter box located at the lowermost position among the stacked filter boxes is engaged with the corresponding shaft member and is installed in the casing at the appropriate position, then consequently all the stacked filter boxes are automatically positioned. Therefore, in such a case, it is sufficient that only the shaft member corresponding to the filter box located at the lowermost position among the stacked filter boxes is provided, and there is no need to provide another shaft member or members. For example, in a case that three filter box 38 are stacked or overlaid and installed at the same time in the first space 28c of the casing 28, only the shaft member 48G or/and the shaft member 48G is/are provided, and there is no need to use the shaft members 48H, 48I, 49H and 49I. In this case, there is no need to form the first groove and the second groove on the frame 50 of each of the middle and upper stage filter boxes 38.

The present invention is described in the claims attached herewith. Other than that, the following concept is also included in the present invention. Namely, a filter box system including the filter box of the present invention a casing or chamber accommodating the filter box and having a member(s) engaging with the first recess and second recess is also a creative concept intended by the present invention.

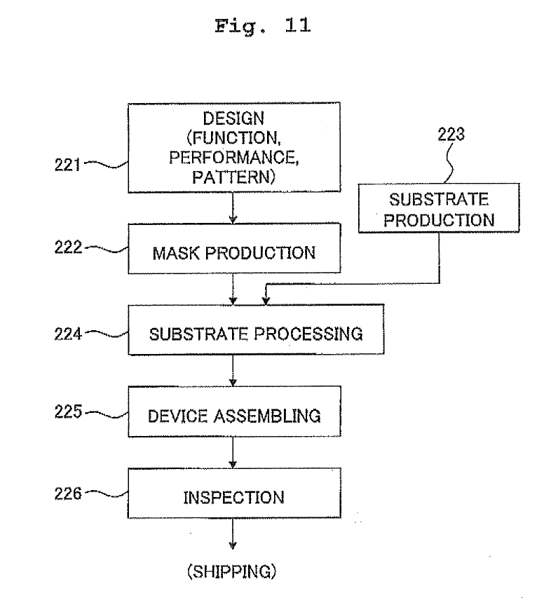

In a case that an electronic device (or a microdevice) such as a semiconductor device or the like is produced by using the exposure apparatus EX of the embodiment described above, as shown in FIG. 11, the electronic device is produced by performing a step 221 of designing the function and the performance of the electronic device; a step 222 of manufacturing a mask (reticle) based on the designing step; a step 223 of producing a substrate (wafer) as a base material for the device and coating the substrate (wafer) with a resist; a substrate-processing step 224 including, for example, a step of exposing the substrate (photosensitive substrate) with the pattern of the mask by the exposure apparatus of the embodiment described above, a step of developing the exposed substrate, and a step of heating (curing) and etching the developed substrate; a step 225 of assembling the device (including processing processes such as a dicing step, a bonding step, and a packaging step); an inspection step 226; and the like.

Therefore, the method for producing the device includes forming a pattern of a photosensitive layer on the substrate by using the exposure apparatus of the embodiment described above, and processing the substrate formed with the pattern (Step 224). According to the exposure apparatus, it is possible to reduce the maintenance cost, and it is possible to improve the exposure accuracy. Therefore, it is possible to produce the electronic device inexpensively and highly accurately.

In the embodiment described above, the air is used as the gas for the air-conditioning. In place of the air, it is also allowable to use, for example, nitrogen gas, noble gas or rare gas (helium, neon, etc.), or a mixed gas of the above-described gases.

The present invention is also applicable to a case that the exposure is performed by using a projection exposure apparatus of the full field exposure type (stepper type), without being limited to only the projection exposure apparatus of the scanning exposure type.

The present invention is also applicable when the exposure is performed by using, for example, an exposure apparatus of the proximity system or the contact system in which any projection optical system is not used.

The present invention is not limited to the application to the process for producing the semiconductor device. The present invention is also widely applicable, for example, to the process for producing a display apparatus including a liquid crystal display element formed on a square or rectangular glass plate, a plasma display, etc., and the process for producing various devices including an image pickup element (COD, etc.), a micromachine, MEMS (Microelectromechanical Systems), a thin film magnetic head, a DNA chip, etc. Further, the present invention is also applicable to the production step when a mash (a photomask, a reticle, etc.), on which mask patterns for various devices are formed, is produced by using the photolithography step.

As described above, it is a matter of course that the present invention is not limited to the embodiments described above, which may be embodied in other various forms within a scope without deviating from the gist or essential characteristics of the present invention.

What is claimed is:

1. A filter holding apparatus which holds a plurality of filters, the filter holding apparatus comprising:
a first filter and a second filter;
a box-shaped first frame which holds the first filter and which has a first protrusion/recess-formed portion provided on at least one side surface of the first frame; and
a box-shaped second frame which holds the second filter, which has a second protrusion/recess-formed portion provided on at least one side surface of the second frame, and which is arranged while being overlapped with the first frame,
wherein the first protrusion/recess-formed portion has a first recess which is arranged between an upper end and a lower end of the at least one side surface of the first frame and which is communicated with a side end of the at least one side surface of the first frame, and a second recess which is communicated with the first recess and which extends toward the upper end of the at least one side surface of the first frame;
the second protrusion/recess-formed portion has a third recess which is arranged between an upper end and a lower end of the at least one side surface of the second frame and which is communicated with a side end of the at least one side surface of the second frame, and a fourth recess which is communicated with the third recess and which extends toward the upper end of the at least one side surface of the second frame; and
a positional relationship of the second recess with respect to the first recess and a positional relationship of the fourth recess with respect to the third recess are different from each other.

2. The filter holding apparatus according to claim 1, wherein a distance from a front surface of the first frame to the second recess is different from a distance from a front surface of the second frame to the fourth recess.

3. The filter holding apparatus according to claim 1, wherein the first recess and the third recess are formed so as to spread to the lower end of the at least one side surface of the first frame and the lower end of the at least one side surface of the second frame, respectively.

4. The filter holding apparatus according to claim 1, wherein the second recess and the fourth recess are formed so as to spread to the side end of the at least one side surface of the first frame and the side end of the at least one side surface of the second frame, respectively.

5. The filter holding apparatus according to claim 1, wherein first tapered portions, each of which has a width gradually narrowed toward the side end of the at least one side surface of one of the first and second frames, are formed in the first and second frames respectively at a position at which the first and second recesses are communicated with each other and a position at which the third and fourth recesses are communicated with each other.

6. The filter holding apparatus according to claim 1, wherein second tapered portions, each of which has a width gradually widened toward the side end of the at least one side surface of one of the first and second frames, are formed in the first and second frames at portions of the first recess and the third recess communicated with the side end of the at least one side surface of the first frame and the second frame, respectively.

7. The filter holding apparatus according to claim 1, wherein the first protrusion/recess-formed portion is provided as first protrusion/recess-formed portions which are formed to have a substantially same shape on a pair of side surfaces of the first frame respectively; and
the second protrusion/recess-formed portion are provided as second protrusion/recess-formed portions which are formed to have a substantially same shape on a pair of side surfaces of the second frame respectively.

8. The filter holding apparatus according to claim 1, wherein fifth recesses are provided between the first recess of the at least one side surface of the first frame and the upper end of the at least one side surface of the first frame and between the third recess of the at least one side surface of the second frame and the upper end of the at least one side surface of the second frame, respectively.

9. The filter holding apparatus according to claim 1, wherein the first filter and the second filter are chemical filters of mutually different types.

10. The filter holding apparatus according to claim 1, wherein the first filter removes an organic matter contained in a gas passing through the first filter; and
the second filter removes at least one of an alkaline substance and an acid substance contained in a gas passing through the second filter.

11. The filter holding apparatus according to claim 1, wherein the first filter is provided as a plurality of pairs of first filters and the first frame is provided as a plurality of pairs of first frames; and
the second filter is provided as a plurality of pairs of second filters and the second frame is provided as a plurality of pairs of second frames.

12. The filter holding apparatus according to claim 1, wherein the first frame and the second frame are arranged to be overlapped with each other via a plate in which a passage for a gas is formed.

13. An exposure apparatus which exposes a substrate with an exposure light via a pattern, the exposure apparatus comprising:
an exposure apparatus-body section which exposes the substrate;
a chamber which accommodates the exposure apparatus-body section;
the filter holding apparatus as defined in claim 1; and
an air-conditioning apparatus which feeds a gas taken in from outside of the chamber into the chamber via the filter holding apparatus.

14. A method for producing a device, comprising:
exposing a photosensitive substrate by using the exposure apparatus as defined in claim 13; and
processing the exposed photosensitive substrate.

15. A filter holding apparatus comprising:
a first filter and a second filter each of which removes a predetermined component contained in a gas; and
a first frame which has a first surface, a second surface facing the first surface, a third surface intersecting the first surface, and a fourth surface facing the third surface, which surrounds the first filter with the first surface, the second surface, the third surface and the fourth surface, and in which a first recess and a second recess are formed in each of the third and fourth surfaces, the first recess having an end arriving at the second surface, and the second recess connecting to the first recess and extending at least in an upward direction;
a second frame which has a first surface, a second surface facing the first surface, a third surface intersecting the first surface, and a fourth surface facing the third surface, which surrounds, the second filter with the first surface, the second surface, the third surface and the fourth surface, and in which a third recess and a fourth recess are formed in each of the third and fourth surfaces, the third recess having an end arriving at the second surface, and the fourth recess connecting to the third recess and extending at least in the upward direction;
wherein a distance between the second recess and the second surface in the first frame is different from a distance between the fourth recess and the second surface in the second frame.

16. The filter holding apparatus according to claim 15, wherein the second recess extends also in a downward direction from the other end of the first recess; and the fourth recess extends also in the downward direction from the other end of the third recess.

17. The filter holding apparatus according to claim 15, wherein the second recess formed in each of the third and fourth surfaces of the first frame is formed so as not to arrive at the upper end of each of the third and fourth surfaces; and the fourth recess formed in each of the third and fourth surfaces of the second frame is formed so as not to arrive at the upper end of each of the third and fourth surfaces.

18. The filter holding apparatus according to claim 15, wherein the first recess and the second recess of the first frame are slidably engaged with a pair of guides provided on the case to guide the first frame to the case; and the third recess and the fourth recess of the second frame are slidably engaged with a pair of guides provided on the case to guide the second frame to the case.
